(19) United States
(12) Patent Application Publication
(10) Pub. No.: US 2013/0042896 A1
(43) Pub. Date: Feb. 21, 2013

(54) EQUIPMENT FOR CLEANING TANKS INTENDED FOR STORING INFLAMMABLE PRODUCTS

(71) Applicants: Boris Drean, Bordeaux (FR); Fabien Lefrancq, Verac (FR)

(72) Inventors: Boris Drean, Bordeaux (FR); Fabien Lefrancq, Verac (FR)

(73) Assignee: Veolia Proprete, Nanterre (FR)

(21) Appl. No.: 13/581,786

(22) PCT Filed: Feb. 17, 2011
(86) PCT No.: PCT/FR2011/050333

§ 371 Date: Oct. 19, 2012

(30) Foreign Application Priority Data
Mar. 30, 2010 (FR) 1052324

(51) Int. Cl. B08B 9/093

(52) U.S. Cl. 134/167 R

(57) ABSTRACT

The invention relates to cleaning equipment for cleaning a tank intended for storing inflammable products and that defines an internal volume (Vint) provided with an opening, this equipment comprising a shutter (1) suitable for closing the opening, a flexible hose (2) that passes through the shutter (1), a trolley (3) sized in order to be introduced into the internal volume (Vint) of the tank, and a cleaning head (4) borne by the trolley (3), connected to the flexible hose (2), and designed in order to spray a cleaning liquid delivered at high pressure by the flexible hose (2). The equipment of the invention also comprises a rod (5) connected to the trolley (3) and passing through the shutter (1), and the trolley (3) comprises a chassis (30) provided with rolling members (300) so as to be able to adopt, in the tank, apposition controlled by an action exerted on the rod (5) in the space (Ext) external to the tank.

The invention generally relates to the field of maintenance.

More precisely, the invention relates to cleaning equipment for cleaning a tank intended for storing inflammable products and that defines an internal volume provided with an opening, this equipment comprising a shutter suitable for closing the opening by isolating the internal volume of the tank of a space external to the tank, a flexible hose passing through a first orifice of the shutter, a trolley sized in order to be able to cross the opening and be selectively introduced into the inner volume of the tank, and a cleaning head borne by the trolley, connected to the flexible hose, and designed to spray a cleaning liquid delivered at high pressure by the flexible hose.

An equipment of this type is for example described in American patent U.S. Pat. No. 5,642,745.

In most cases, the degassing and cleaning operations of tanks or storage tanks are carried out thanks to the intervention, within the facility, of an operator introduced beforehand through the manhole and supervised from the outside by another operator.

However, in as far as they are carried out in confined spaces and in explosive atmospheres, these interventions are neither risk-free nor free from potential noxiousness, despite them respecting the strict safety procedures.

Hence, different systems have been developed in order to prevent direct human intervention in the cleaning and degassing operations of tanks or cisterns.

These systems particularly comprise robots such as described in aforementioned U.S. Pat. No. 5,642,745 or in European patent EP 0918 576, and fixed equipment with articulated arms such as described for example in American patent U.S. Pat. No. 6,889,920.

Whatever their type, these known systems having a complex and/or difficult usage, require the intervention of several operators and/or lifting tools due to their heavy weight, and/or the fact that they exhibit electric hazards.

In this context, the object of the present invention is to propose an equipment exempt from one at least of these drawbacks.

To this end, the equipment of the invention, further conforms to the generic definition given in the aforementioned preamble, is substantially characterized in that it further comprises a rod connected to the trolley and passing through a second orifice of the shutter and in that the trolley comprises a chassis provided with rolling members, the trolley thus able to adopt, in the internal volume, a position monitored by an action exerted on the rod in the space external to the tank.

Preferably, the chassis exhibits a tubular structure comprising at least two bases spaced apart from each other and spurs connecting the two bases, this structure surrounding a protected space, and the cleaning head being fixed to the chassis and arranged in the protected space.

Furthermore, it is advantageous, to provide that the cleaning head exhibits several nozzles rotatably mounted around at least a first axis and driven in rotation, in operation, by the ejection of the cleaning liquid.

The cleaning head may even comprise a stator and a rotor, the nozzles being rotatably mounted around the first axis on the rotor, and the rotor itself being rotatably mounted on the stator around a second axis non-parallel to the first axis.

The equipment of the invention may also comprise an exhaust vent, an exhaust duct, a gas analyzer and an air pump, the exhaust vent being mounted on the trolley and provided with a float, the exhaust duct passing through a third orifice of the shutter and connecting the exhaust vent to the analyzer and the air pump channeling the air coming from the exhaust vent to the analyzer.

Particularly, the equipment may hence, comprise means for continuously analyzing the gases contained within the tank.

The rolling members may for example comprise four wheels or more.

Preferably, one at least of the chassis structure bases forms a support polygon for the trolley.

Furthermore, the rod is preferably made from an electrically conductive material, particularly a conductive polymer, and may be connected to the cleaning head.

Other characteristics and advantages of the invention will become apparent from the following description, for reference only and in no way limiting, with reference to the accompanying drawings, in which:

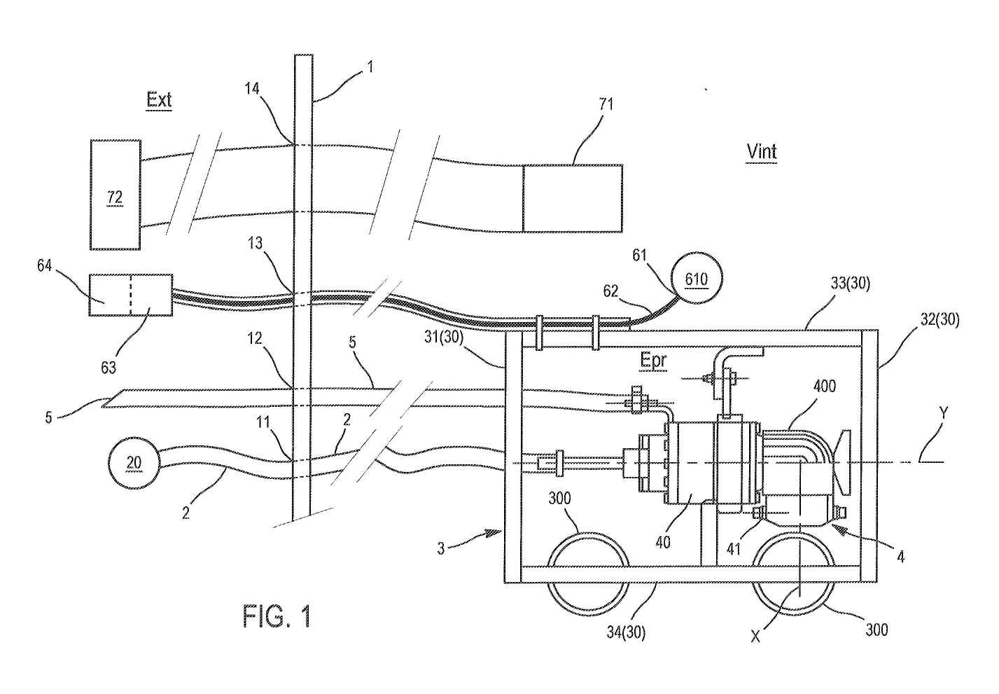

FIG. 1 is a lateral schematic view of an equipment conform to the invention; and

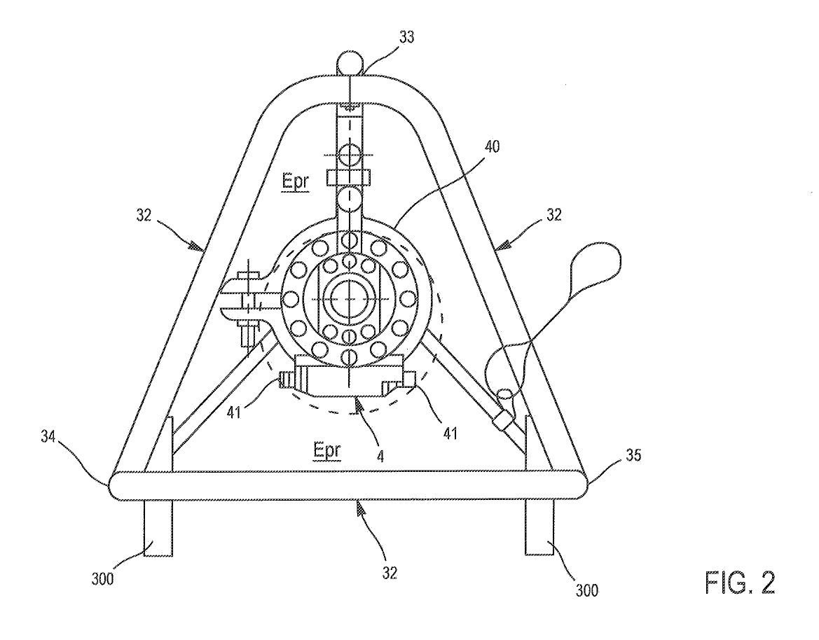

FIG. 2 is a view of a trolley belonging to this equipment and viewed from its front base.

The main members illustrated on these figs. and evoked in the present description are identified by references between brackets or not, the references between brackets being allocated to the assemblies to which belong the members identified by references without brackets.

As aforementioned, the invention relates to a cleaning equipment making it possible to clean a tank (not shown) intended for the storage of inflammable products and that defines an internal volume Vint, provided with an opening.

This equipment comprises at least a shutter 1, a flexible hose 2, a trolley 3, a cleaning head 4, and a rod 5.

The shutter 1 is designed for blocking the opening such as to isolate the internal volume Vint from the tank of the space external to the tank, marked Ext.

The trolley 3 is sized in order to be able to pass through the opening, hence able to be easily introduced into the internal volume Vint of the tank from the Ext. space.

The cleaning head 4 which is borne by the trolley 3, is connected to a high pressure pump 20 by means of the flexible hose 2 which crosses an orifice 11 of the shutter 1.

The cleaning head 4, is designed to spray a cleaning liquid pumped by the high pressure pump 20 and delivered to the head 2 by the flexible hose 2.

This head 4 typically comprises a stator 40, a rotor 400, and a plurality of nozzles 41, these nozzles being rotatably mounted around at least a first axis X and driven in rotation, in operation, by the ejection of the cleaning liquid.

For example, the nozzles 41 are rotatably mounted around the first axis X on the rotor 400, and the rotor 400 is itself rotatably mounted on the stator 40 around a second axis Y non parallel to the first axis X.

The rod 5 is connected to the trolley 3 and passes through a second orifice 12 of the shutter 1.

Furthermore, the trolley 3 comprises a chassis 30 provided with rolling members 300, for example constituted of four wheels or more.

Thanks to this arrangement, the trolley 3 may adopt, in the internal volume Vint, a position monitored by an action exerted on the rod 5 in the Ext space, external to the tank to be cleaned.

Preferably, the chassis 30 exhibits a tubular structure comprising two bases 31 and 32 spaced apart from each other, and spurs 33, 34 and 35 connecting these two bases 31 and 32 together.

The tubular structure of the chassis 30 thus defines a protected space Epr which it surrounds from all parts and within which the cleaning head 4 is arranged.

As the figs. show, the stator 40 of the head 4 is for example fixed to each of the spurs 33, 34 and 35 of the chassis 30, and the wheels 300 are mounted in free rotation on the lower spurs 34 and 35.

As illustrated in the figs, the bases 31 and 32 of the chassis 30 are for example identical.

However, even though this is not the case, it is judicious that at least one of these bases 31 and 32 forms a support polygon for the trolley 3.

The rod 5, which is advantageously made from an electrically conductive material such as a semi-rigid conductive polymer, is directly connected to the stator 40 of the cleaning head 4 to allow for the electric charges which may accumulate in the cleaning head 4 to flow towards the outside Ext.

Preferably, the equipment of the invention further comprises an exhaust vent 61, an exhaust duct 62, a gas analyzer 63 and an air pump 64.

The exhaust vent 61 is mounted on the trolley 3 and the exhaust duct 61, which passes through a third orifice 13 of the shutter 1, connects the exhaust vent 61 to the analyzer 63.

This exhaust vent 61 is preferably provided with a float 610 making it possible to prevent the liquid seeping into the exhaust duct 62.

The air pump 64 channels the air from the exhaust vent 61 to the analyzer 63 which may thus continuously monitor the gas concentrations contained within the tank in order to evaluate the explosion hazard.

The equipment of the invention may also comprise a suction pump 72 arranged on the outside

Ext of the tank and connected to the internal volume Vint of this tank by a suction tube 71 passing through a fourth orifice 14 of the shutter 1.

The trolley 3 is made from materials selected for minimizing all inflammation and explosion hazards, the chassis 30 being for example made from stainless steel covered by a rubber coating, and the wheels 300 made from one or several antistatic materials.

The equipment of the invention may also comprise a camera embedded on the trolley 3 making it possible to inspect the tank to be cleaned, as well as an ultrasound detector making it possible to check the integrity of this tank.

1. A cleaning equipment for cleaning a tank for storing inflammable products and that defines an internal volume (Vint) provided with an opening, this equipment comprising a shutter (1) suitable for closing the opening by isolating the internal volume (Vint) from the space external (Ext) to the tank, a flexible hose (2) that passes through a first orifice (11) of the shutter (1), a trolley (3) sized to be able to pass through the opening and be selectively introduced into the internal volume (Vint) of the tank, and a cleaning head (4) borne by the trolley (3), connected to the flexible hose (2) and designed to spray a cleaning liquid delivered at high pressure by the flexible hose (2), and a rod (5) connected to the trolley (3) and passing through a second orifice (12) of the shutter (1) wherein the trolley (3) comprises a chassis (30) provided with roiling members (300), the trolley (3) thus being able to adopt, in the internal volume (Vint), a position monitored by an action exerted on the rod (5) in the space (Ext) external to the tank.

2. The equipment according to claim 1, wherein the chassis (30) exhibits a tubular structure comprising at least two bases (31, 32) spaced apart from each other and spurs (33-35) connecting these two bases (31, 32), this structure surrounding a protected space (Epr), and in that the cleaning head (4) is fixed to the chassis (30) and arranged in the protected space (Epr).

3. The equipment according to claim 1. wherein the cleaning head (4) exhibits several nozzles (41) rotatably mounted around at least a first axis (x) and driven in rotation, in operation, by the ejection of the cleaning liquid.

4. The equipment according to claim 3, wherein the cleaning head (41) further comprises a stator (40) and a rotor (400), in that the nozzles (41) are rotatably mounted around a first axis (x) on the rotor (400), and in that the rotor (400) is itself rotatably mounted on the stator (40) around a second axis (y) non parallel to the first axis (x).

5. The equipment according to claim 1, further comprising an exhaust vent (61), an exhaust duct (62), a gas analyzer (63) and an air pump (64), the exhaust vent (61) being mounted on the trolley (3) and provided with a float (610), the exhaust duct (62) passing through a third orifice (13) of the shutter (1) and connecting the exhaust vent (61) to the analyzer (63) and the air pump (64) channeling the air from the exhaust vent (61) to the analyzer (63).

6. The equipment according to claim 1, wherein the rolling members (300) comprises at least four wheels (300).

7. The equipment according to with claim 2, wherein at least one of said bases (31, 32) forms a support polygon for the trolley (3).

8. The equipment according to claim 1, wherein the rod (5) is made from an electrically conductive material.

9. The equipment according to claim 1, wherein the rod (5) is connected to the cleaning head (4).

10. The equipment according to claim 1, further comprising means (61, 63, 64) for continuously analyzing the gases contained in the tank.
